(19) United States
(12) Patent Application Publication
(10) Pub. No.: US 2025/0160253 A1
(43) Pub. Date: May 22, 2025

(54) ROBOTIC FRUIT HARVESTING SYSTEM AND METHOD

(71) Applicant: Monash University, Melbourne, Victoria (AU)

(72) Inventors: Chao Chen, Melbourne, Victoria (AU); Hongyu ZHOU, Melbourne, Victoria (AU); Xing WANG, Melbourne, Victoria (AU); Wesley AU, Melbourne, Victoria (AU)

(73) Assignee: Monash University, Melbourne, Victoria (AU)

(21) Appl. No.: 18/723,351

(22) PCT Filed: Dec. 21, 2022
(86) PCT No.: PCT/AU2022/051552

§ 371 Date: Jun. 21, 2024

(30) Foreign Application Priority Data
Dec. 22, 2021 (AU) 2021904217

(51) Int. Cl. A01D 46/30; A01D 46/24; B25J 9/16; B25J 15/06; B25J 15/10

(52) U.S. Cl. CPC A01D 46/30; A01D 46/24; B25J 9/1666; B25J 9/1697; B25J 15/0616; B25J 15/10

(57) ABSTRACT

Embodiments relate generally to a robotic fruit picking apparatus and a method of picking fruit. An example apparatus includes: a chassis; a robotic arm supported by the chassis and having an end effector, wherein the end effector includes a plurality of grippers and an extendable suction element; a vision system carried by the chassis and configured to identify pieces of fruit for picking; and a control system carried by the chassis and in communication with the vision system to control the robotic arm to pick identified pieces of fruit using the end effector. The control system may be configured to operate in a first mode to control the extendable suction element to extend the suction element towards a piece of fruit. The control system may be further configured to operate in a second mode following the first mode to retain contact with the piece of fruit by applying suction while freely allowing extension or retraction of the suction element based on movement of the piece of fruit.

### TECHNICAL FIELD

Embodiments generally relate to a robotic apparatus for picking fruit. In particular, embodiments relate to an end effector, image processing, and position determination for a robotic fruit picking apparatus.

### BACKGROUND

The adoption of a robotic apparatus for picking fruit may provide economic benefits and reduce wear on a human worker under strenuous working conditions. For example, a robotic apparatus may increase an orchard's production levels for a reduced cost of labour. However, existing apparatuses and methods for fruit picking tend to be inefficient and unreliable.

It is desired to address or ameliorate one or more shortcomings or disadvantages associated with prior apparatuses and methods for robotically picking fruit, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a robotic fruit picking apparatus. The robotic fruit picking apparatus may include: a chassis; a robotic arm supported by the chassis and having an end effector, wherein the end effector may include a plurality of grippers and an extendable suction element; a vision system carried by the chassis that may be configured to identify pieces of fruit for picking; and a control system carried by the chassis that may be in communication with the vision system to control the robotic arm to pick identified pieces of fruit using the end effector.

In some embodiments, the control system is configured to operate in a first mode to control the extendable suction element to extend the suction element towards a piece of fruit. The control system may be configured to operate in a second mode following the first mode to retain contact with the piece of fruit by applying suction while freely allowing extension or retraction of the suction element based on the movement of the piece of fruit.

In some embodiments, the plurality of grippers may comprise gripper fingers, where each of the gripper fingers has an inner wall and an outer wall coupled to the inner wall by a plurality of tendons. Each gripper finger may include a plurality of reinforcing plates to reinforce the respective tendons. The gripper fingers may be resiliently deformable when gripping the piece of fruit. The gripper may include three, four or five gripper fingers.

In some embodiments, the suction element includes: a suction aperture defined by an end face of the suction element; an end portion that may be configured to allow flexion relative to a longitudinal axis of the suction element, wherein the end portion may be compressible along the longitudinal axis of the suction element.

In some embodiments, the robotic fruit picking apparatus further includes: a suction line and a pressure sensor to sense pressure in the suction line, wherein the suction line may run through the suction element and the pressure sensor may be configured to provide a pressure output signal to the control system, wherein the control system may be configured to determine whether the suction element has applied suction to a piece of fruit based on the pressure output signal.

In some embodiments, the control system is configured to operate the suction element pneumatically.

The vision system may configured to identify, from the captured and processed images, pieces of fruit for picking and sort them into a picking order, and to provide the output to the control system. The vision system may be used in pose estimation to determine the path of the robotic arm.

The imaging subsystem may be configured to identify interference objects in the images, and to output interference object identification information to the control unit. The control unit may be configured to determine movement of the robotic arm and end effector to avoid collision with the interference objects based on the interference object identification information. The control system may configured to operate the suction element in a retraction mode, after either the extension mode or passive mode, to retract the suction element towards the one end of the robotic arm.

In some embodiments, the control system is configured to control the gripper to adopt an expanded position, where the gripper fingers are expanded about a longitudinal axis of the end effector and a contracted position where the gripper fingers are contracted about the longitudinal axis of the end effector. The control system may be configured to operate the robotic arm to rotate the end effector about the longitudinal axis of the end effector to pick the piece of fruit when the gripper is in the contracted position.

The robotic fruit picking apparatus may further include: a movement system coupled to the main body to facilitate movement of the main body relative to ground.

Some embodiments relate to a robotic fruit picking apparatus. The robotic fruit picking apparatus may include: a main body; a robotic arm coupled to the main body; an end effector coupled to a first end of the robotic arm, the end effector may include: a gripper including a plurality of gripper portions to grip a piece of fruit; a suction member extendable from the end effector; and a control unit carried by the main body, wherein, the control unit may be configured to operate the suction member in an extension mode to apply suction and extend the suction member from the end effector towards the piece of fruit, and to operate the suction member in a passive mode after the extension mode, wherein in the passive mode, the suction member can move freely relative to the gripper while applying the suction.

In some embodiments, the robotic fruit picking apparatus includes a vision system coupled to the main body comprising: image capturing devices; wherein the vision system may be configured to use the image capturing devices to identify pieces of fruit for picking. In some embodiments, the vision system may be further configured to determine a collision free picking path for the apparatus to pick fruit.

Some embodiments relate to a computer-implemented method for picking pieces of fruit. The computer-implemented method for picking pieces of fruit may comprise: operating a robotic end effector in an extension mode to extend a suction element toward a piece of fruit, wherein the suction element may be configured to apply suction to the piece of fruit; operating the end effector in a passive mode, wherein in the passive mode the suction element can move freely in a longitudinal direction along a longitudinal axis of the end effector while applying suction by the suction element to the piece of fruit; directing the end effector towards the piece of fruit to pick the piece of fruit.

The computer-implemented method for picking pieces of fruit may further comprise: actuating a gripper coupled to the end effector to grasp the piece of fruit for picking; rotating the end effector about a longitudinal axis of the end effector to dislodge the piece of fruit.

The computer-implemented method for picking pieces of fruit may further comprise: directing the end effector towards a storage container; operating the end effector in a retraction mode to retract the suction element toward the end effector, wherein the suction element stops applying suction to the piece of fruit; actuating the gripper of the end effector to release the piece of fruit into the storage container.

In some embodiments, the computer-implemented method further comprises: generating a software-defined fruit map based at least in part on data received by a vision system; determining a harvesting sequence based at least in part on the fruit map; and determining an end effector approach angle for each piece of fruit within the fruit map based at least in part on the fruit map, the harvesting sequence, and pose estimation.

### BRIEF DESCRIPTION OF DRAWINGS

Embodiments are described in further detail below, by way of example and with reference to the accompanying drawings, in which:

FIG. 1 is a block diagram of a first control system of a robotic fruit picking apparatus according to some embodiments;

FIG. 2 is a block diagram of an alternate second control system of the robotic fruit picking apparatus of FIG. 1;

FIG. 3 is a schematic diagram of a pneumatic system according to some embodiments;

FIG. 4 is a schematic diagram of a pneumatic system according to some embodiments;

FIG. 5 is a perspective view of an end effector of a robotic fruit picking apparatus according to some embodiments;

FIG. 6 is a perspective view of a gripper portion of the end effector of FIG. 5 according to some embodiments;

FIG. 7 is a process flow diagram of a computer-implemented method for picking pieces of fruit;

FIG. 8A is a diagram illustrating a reference frame for an end effector;

FIG. 8B is a diagram illustrating a reference frame for a piece of fruit;

FIG. 9A is an illustration of an example result of a depth-priority search according to some embodiments;

FIG. 9B is an illustration of an example result of a cluster-priority search according to some embodiments;

FIG. 10 is a flow chart illustrating a cluster-priority search process according to some embodiments;

FIG. 11 is an illustration of the workspace boundaries of the robotic fruit picking apparatus according to some embodiments;

FIG. 12 is an illustration of a collision cylinder about the end effector of FIG. 5 according to some embodiments;

FIG. 13a is a side view of a contracted gripper of the end effector of FIG. 5;

FIG. 13b is an end view of a contracted gripper of the end effector of FIG. 5;

FIG. 14a is a side view of an expanded gripper of the end effector of FIG. 5;

FIG. 14b is an end view of an expanded gripper of the end effector of FIG. 5; and

FIG. 15 is an illustration of a control sequence of the end effector of FIG. 5 according to some embodiments.

### DESCRIPTION OF EMBODIMENTS

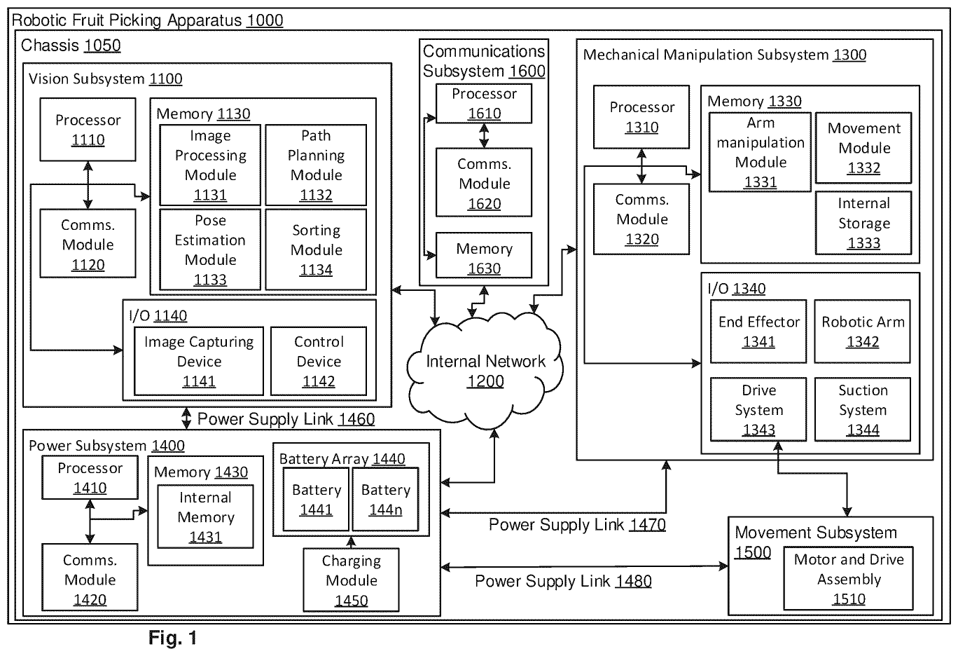

FIG. 1 is a block diagram of a first control system of a robotic fruit picking apparatus (RFPA) 1000 according to some embodiments. The RFPA 1000 comprises a number of subsystems that are configured to communicate with each other to pick fruit. As shown in FIG. 1, the RFPA 1000 comprises or is coupled to a chassis 1050. In some embodiments, chassis 1050 may comprise a frame or an enclosed structure suitable of containing, holding, carrying, or otherwise housing the subsystems RFPA 1000. In some embodiments, the subsystems of RFPA 1000 may comprise separate housings that when coupled form chassis 1050. The RFPA 1000 comprises a vision subsystem 1100 for capturing and processing images to determine fruit to pick and the path of the apparatus, a mechanical manipulation subsystem 1300 to control the movement of the apparatus, a power subsystem 1400 to control and provide power to the apparatus, a movement subsystem 1500 to allow movement of the apparatus relative to the working environment, and a communications subsystem 1600 to provide means of external communication with the RFPA 1000, as well as to control the subsystems of RFPA 1000. Each subsystem is in communication with each other via an internal network 1200.

Vision subsystem 1100 comprises a processor 1110 and a memory 1130 accessible to processor 1110. Processor 1110 may be configured to access data stored in memory 1130, to execute instructions stored in memory 1130, and to read and write data to and from memory 1130. Processor 1110, and any processor defined hereafter unless otherwise stated, may comprise one or more microprocessors, microcontrollers, central processing units (CPUs), application specific instruction set processors (ASIPs), or other processor capable of reading and executing instruction code.

Memory 1130, and any memory defined hereafter unless otherwise stated, may comprise one or more volatile or non-volatile memory types, such as RAM, ROM, EEPROM, or flash, for example. Memory 1130 may be configured to store executable applications for execution by processor 1110. For example, memory 1130 may store at least one sorting module 1134 configured to sort identified fruit into a picking order.

To facilitate communication with other subsystems within RFPA 1000, such as mechanical manipulation subsystem 1300, vision subsystem 1100 further comprises a communications module 1120. Communications module 1120 may allow for wired and/or wireless communication between vision subsystem 1100 and internal systems. Communications module 1120, and any communications module defined hereafter unless otherwise stated, may facilitate communication via direct connection, Bluetooth, USB, Wi-Fi, Ethernet, or via a telecommunications network, for example. According to some embodiments, communication module 1120 may facilitate communication with internal devices and systems via internal network 1200.

Internal network 1200 may comprise one or more communication methods that facilitate communication between elements of apparatus 1000. Internal network 1200 may facilitate communication via communications modules within each subsystem of the RFPA 1000. The communications modules of the subsystems of the RFPA 1000 may communicate via methods described herein.

Vision subsystem 1100 further comprises input and output peripherals (I/O) 1140 to allow a user to communicate with RFPA 1000, and to allow vision subsystem 1100 to capture images. I/O 1140 may comprise at least one image capturing device 1141, which in some embodiments may be a webcam, a compact digital camera, or an action camera, for example. In some embodiments, the at least one image capturing device 1141 may comprise a Intel RealSense computer vision system, for example. In some embodiments, image capturing device 1141 may provide point cloud data of the environment. I/O 1140 may comprise a control device 1142, which in some embodiments may be a touchscreen display, as well as one or more of a keyboard, a mouse, a camera, a microphone, a speaker, buttons, sliders, and LEDs, for example.

The mechanical manipulation subsystem 1300 comprises a processor 1310 and a memory 1330 accessible to processor 1310. Processor 1310 may be configured to access data stored in memory 1130, to execute instructions stored in memory 1330, and to read and write data to and from memory 1330. Memory 1330 may be configured to store executable applications for execution by processor 1310. For example, memory 1330 may store at least one movement module 1332 configured to control the physical movement of the RFPA 1000. Memory 1330 may also store data in a data storage location such as internal storage 1333. According to some embodiments, internal storage 1333 may store a current pose, or position, of each piece of the robotic arm 1342 in three-dimensional space, and optionally historic arm positions, accessible to the arm manipulation module 1331, for example. Where, the three-dimensional space has six degrees of freedom including, translation along three perpendicular axes, and rotation about each of the three axes.

To facilitate communication with other subsystems within RFPA 1000, such as vision subsystem 1100, mechanical manipulation subsystem 1300 further comprises a communications module 1320. Communications module 1320 may allow for wired and/or wireless communication between mechanical manipulation subsystem 1300 and internal systems. According to some embodiments, communication module 1320 may facilitate communication with internal and devices and systems via internal network 1200.

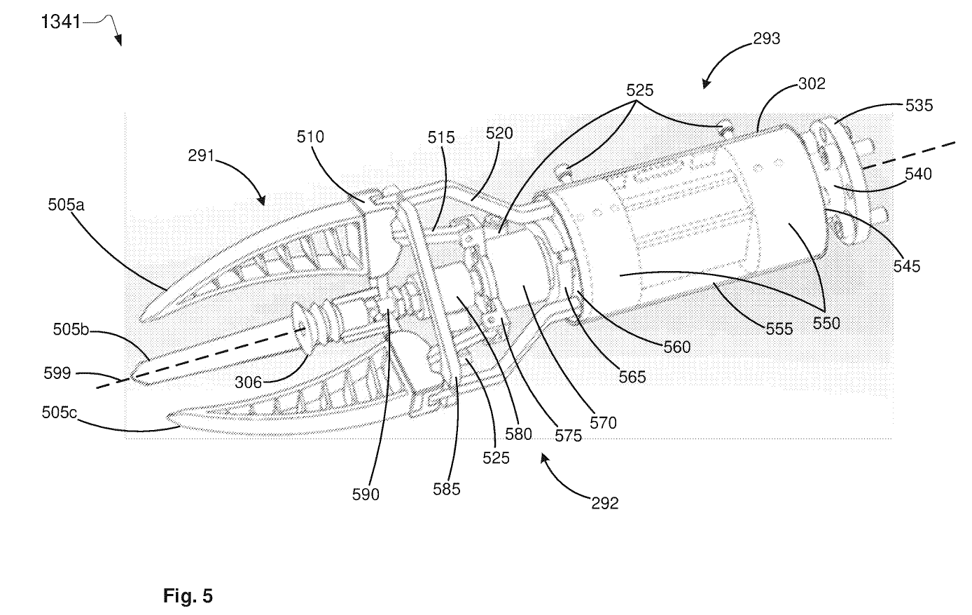

Mechanical manipulation subsystem 1300 further comprises input and output peripherals 1340 to allow the subsystem to communicate externally. I/O 1340 may comprise an end effector 1341 (FIG. 5). I/O 1340 may comprise a robotic arm 1342, which in some embodiments may be off the shelf or privately manufactured, for example. In some embodiments, robotic arm 1342 may allow for rotational and/or translational movement. I/O 1340 may comprise a drive system 1343, which may be a motor control board configured to communicate with and control movement subsystem 1500. I/O 1340 may comprise a suction system 1344, which in some embodiments may be off the shelf or privately manufactured, for example.

The movement subsystem 1500 comprise at least one motor and drive assembly. In some embodiments, the drive assembly may comprise at least one wheel, track, or leg, for example.

The power subsystem 1400 comprises a processor 1410 and a memory 1430 accessible to processor 1410. Processor 1410 may be configured to access data stored in memory 1430, to execute instructions stored in memory 1430, and to read and write data to and from memory 1430. Memory 1430 may be configured to store executable applications for execution by processor 1410. For example, memory 1430 may store data in internal memory 1431 configured for access by processor 1410.

To facilitate communication with other subsystems within RFPA 1000, such as mechanical manipulation subsystem 1300, power subsystem 1400 further comprises a communications module 1420. Communications module 1420 may allow for wired and/or wireless communication between power subsystem 1400 and internal systems. According to some embodiments, communication module 1420 may facilitate communication with internal devices and systems via internal network 1200.

Power subsystem 1400 may further comprise a battery array 1440 comprising at least one battery 1441. In some embodiments, battery array 1440 may comprise a plurality of batteries 1441 to 144n. Battery 1441 may comprise a rechargeable battery, for example, a nickel-metal hydride battery, a lithium-ion battery, a lead-acid battery, or a nickel-cadmium battery. To recharge battery array 1440, power subsystem 1400 may further comprise a charging module 1450, including a power port for connection to an external power source, and a PCB to monitor and control the inflow of electrical energy to battery array 1440. RFPA 1000 may utilise charging module 1450 and the connected external power source to directly provide power to the subsystems of the RFPA 1000. Power subsystem 1400 may also comprise a first power supply link 1460, a second power supply link 1470, and a third power supply link 1480, providing an electrical connection to the internal subsystems of the apparatus 1000. This will allow vision subsystem 1100, mechanical manipulation subsystem 1300, and movement subsystem 1500 to receive the electrical energy required to perform their respective functions from power subsystem 1400. In some embodiments, the RPFA 1000 may omit battery array 1440 and battery 1441, and utilise charging module 1450 connected to an external power source to directly supply power to the systems of the RFPA 1000. The external power source may be a generator or a connection to mains electricity, for example.

Communications subsystem 1600 comprises a processor 1610 and a memory 1630 accessible to processor 1610. Processor 1610 may be configured to access data stored in memory 1630, to execute instructions stored in memory 1630, and to read and write data to and from memory 1630. Memory 1630 may be configured to store executable applications for execution by processor 1610. For example, memory 1630 may store data in an internal memory (not shown) configured for access by processor 1610.

To facilitate communication with other subsystems within RFPA 1000 such as that mechanical manipulation subsystem 1300, as well as external systems, communications subsystem 1600 further comprises a communications module 1620. Communications module 1620 may allow for wired and/or wireless communication between communications subsystem 1600 and internal systems, and in some embodiments, external computing devices and components. According to some embodiments, communication module 1620 may facilitate communication with internal devices and systems via internal network 1200.

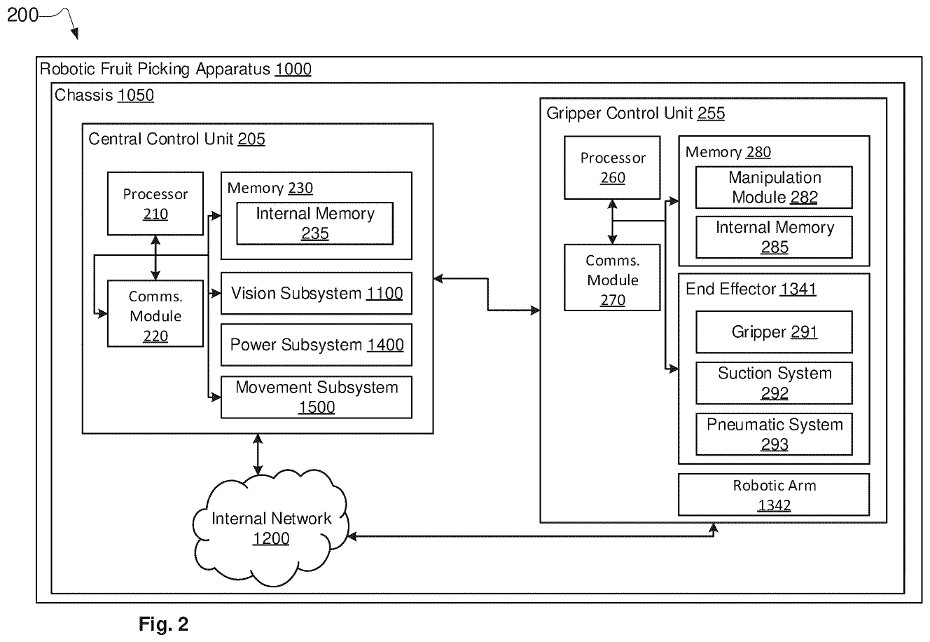

FIG. 2 is a block diagram of an alternate second control system 200 of the RFPA 1000 as described further below.

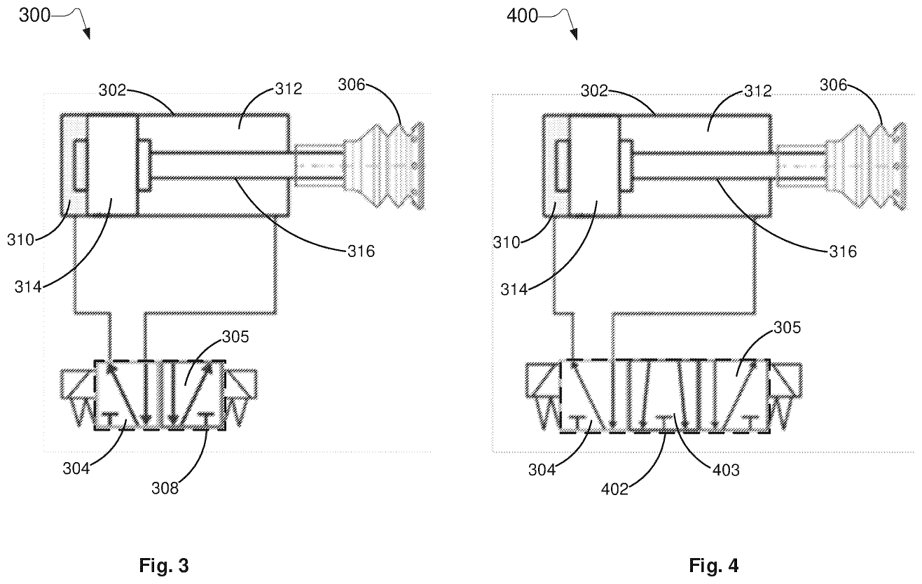

FIG. 3 schematically illustrates a pneumatic system 300 comprising a pneumatic cylinder 302, a suction element 316, an end portion 306, and a pneumatic valve 308. Pneumatic cylinder 302 comprises a first chamber 310, a second chamber 312, and a piston 314. Pneumatic valve 308 comprises a 2-position, 4-way, 5 ported valve, allowing for pneumatic cylinder 302 to be in an extended state or a retracted state. The two positions corresponding to the extended state and the retracted state of pneumatic valve 308 are determined by solenoid 304 and solenoid 305. When solenoid 304 is actuated, the pneumatic system 300 will be in the extension state. When solenoid 305 is actuated, the pneumatic system 300 will be in the retraction state. Only one solenoid, either solenoid 304 or solenoid 305 may be actuated at any one time.

When pneumatic system 300 is in the extended state, suction element 316 is extended to the right in FIG. 3, away from pneumatic cylinder 302. This is accomplished by closing an exhaust port connected to the first chamber 310 and opening an exhaust port connected to the second chamber 312 while supplying pressurised gas to the first chamber 310, which applies a force to piston 314 in the first chamber 310 greater than that of the force applied to piston 314 in the second chamber 312. The supply of pressurised gas to the first chamber 310 is then shut off, leaving pneumatic cylinder 302 in the extended state. When pneumatic system 300 is in the retracted state, suction element 316 is withdrawn to the left in FIG. 3, into pneumatic cylinder 302. This is accomplished by closing an exhaust port connected to the second chamber 312 and opening an exhaust port connected to the first chamber 310 while supplying pressurised gas to the second chamber 312, which applies a force to piston 314 in the second chamber 312 greater than that of the force applied to piston 314 in the first chamber 310. The supply of pressurised gas to the second chamber 312 is shut off, leaving pneumatic cylinder 302 in the retracted state.

FIG. 4 is a pneumatic system 400 comprising pneumatic cylinder 302, suction element 316, end portion 306, and a pneumatic valve 402. Pneumatic valve 402 may comprise a 3-position, 4-way, 5 ported open centre valve, allowing for pneumatic cylinder 302 to be in one of three states, either an extended state, a retracted state, or a passive state, where the extended and retracted states are the same as described in relation to pneumatic system 300. In some embodiments, pneumatic valve 302 may comprise a 3-position exhaust centre valve or a 3-position, 5 ported normally open valve. The three positions of pneumatic valve 308 are determined by solenoid 304, solenoid 305, and solenoid 403. When solenoid 304 is actuated, the pneumatic system 300 will be in the extension state. When solenoid 305 is actuated, the pneumatic system 300 will be in the retraction state. When solenoid 403 is actuated, the pneumatic system 300 will be in the passive state. Only one of solenoid 304, solenoid 305, or solenoid 403 may be actuated at any one time. When pneumatic system 400 is in the passive state, exhaust ports connected to the first chamber 310 and the second chamber 312 are opened, and the supply of pressurised gas to either chamber is shut off, causing neither chamber to apply force to piston 314. This allows piston 314 to move freely within pneumatic cylinder 302 under forces applied externally via suction element 316.

FIG. 5 shows an example end effector 1341 of the robotic fruit picking apparatus 1000 according to some embodiments. The end effector 1341 comprises a gripper 291, a suction system 292, and a pneumatic system 293. The gripper 291 of the end effector 1341 acts to clasp and carry the piece of fruit.

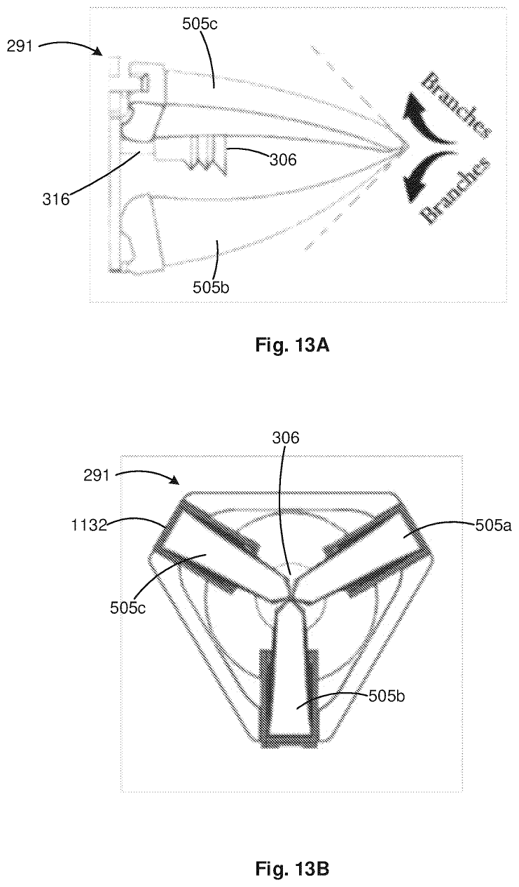

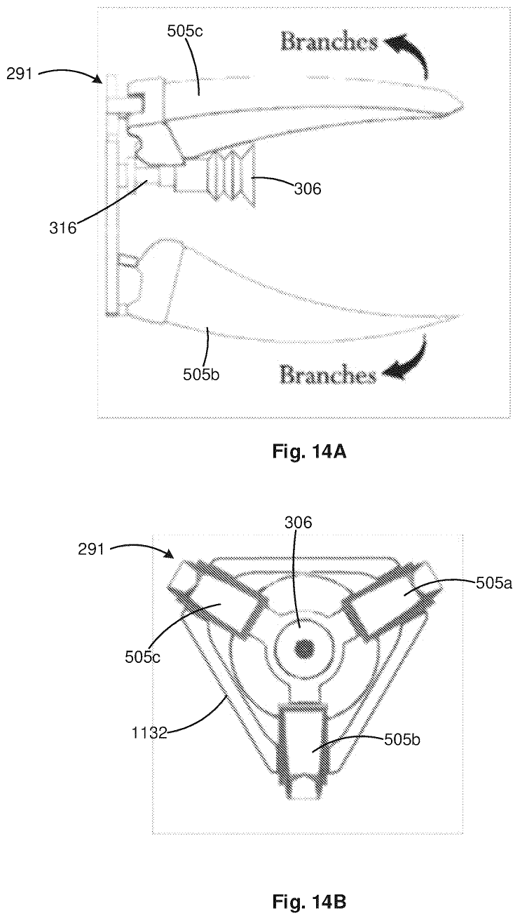

In various embodiments, the gripper may also act to redirect branches and obstacles within the path of the end effector 1341 (FIG. 13A). In some embodiments, end effector 1341 is coupled to robotic arm 1342 via mounting plate 535. Mounting plate 535 may be coupled to raise plate 540 to allow access to mounting points on mounting plate 535. According to some embodiments, the gripper 291 may comprise at least three appendages or gripper portions (shown as three gripper portions 505a, 505b and 505c in FIG. 5, but generalised as 505a-505n), gripper portion base 510, push bar 515, supporting beam 520, cylinder cap 560, stage 1 piston 570, push bar base 575, and rigid ring 585.

According to some embodiments, to actuate the gripper portions 505a to 505n, each gripper portion 505 is coupled to a gripper portion base 510. Each gripper portion base 510 is then coupled to a push bar 515 and a supporting beam 520. That is, each gripper portion base 510 is coupled to supporting beam 520 at an outer point distanced further from the longitudinal axis 599 of end effector 1341 than the inner point where it is coupled to the push bar 515, and is configured to rotate about this outer point. Supporting beams 520 of each gripper portion 505a to 505n are coupled equidistantly from the longitudinal axis 599 of the end effector 1341 via a rigid ring 585. Supporting beams 520 and rigid ring 585 are coupled to cylinder cap 560, and are considered static components. That is, supporting beams 520, rigid ring 585, and cylinder cap 560 move dependent on the movement of end effector 1341. Each push bar 515 is coupled to push bar base 575, which is coupled to the stage 1 piston 570. The at least three gripper portions 505a-505n, each gripper portion base 510, each push bar 515, stage 1 piston 570, and push bar base 575 are considered dynamic components. That is, the at least three gripper portions 505a-505n, each gripper portion base 510, each push bar 515, stage 1 piston 570, and push bar base 575 move dependently on end effector 1341, and additionally may move independently of end effector 1341.

Stage 1 piston 570 is actuated along the longitudinal axis 599 of the end effector 1341 pneumatically by pneumatic system 293. This actuation will cause the movement of push bar base 575 and consequently each push bar 515 of each gripper portion 505a to 505n. Movement of each push bar 515, which is coupled to a respective finger base 510, will then cause rotational movement of a respective portion base 510 and consequently movement of each gripper portion 505a to 505n. That is, as stage 1 piston 570 is actuated and extended along the longitudinal axis 599 of the end effector 1341 away from cylinder cap 560 rotation is induced. This rotation movement in the gripper portion base 510 of each gripper portion 505a to 505n will cause the gripper portions 505a to 505n to adopt an expanded position. In the expanded position, the gripper portions 505a to 505n are expanded about the longitudinal axis 599 of the end effector 1341. Stage 1 piston 570 may also be actuated to move in an opposite direction to that required by the expanded position. When stage 1 piston is actuated and retracted along the longitudinal axis 599 of the end effector 1341 towards cylinder cap 560 rotation is induced. This rotation movement in the gripper portion base 510 of each gripper portion 505a to 505n will cause the gripper portions 505a to 505n to adopt a contracted position. In the contracted position, the gripper portions 505a to 505n are contracted about the longitudinal axis 599 of the end effector 1341.

Suction system 292 may comprise stage 2 piston 580, suction damper 590, and an end portion 306, which may be called a suction tip or a suction cup. As previously described in FIGS. 3 and 4, suction element 316 is controlled to be in an extension, retraction, or passive mode, dependent on the configuration of the stage 2 piston 580. End portion 306 is coupled to suction damper 590, which then couples to suction element 316. In some embodiments, the end face of the end portion 306 has a thin thickness and is made of a soft material, such as a rubber or silicone material, further increasing efficiency when creating a suction seal.

In some embodiments, end portion 306 may be of a bellows-like design. The bellows-like design may be helpful for accommodating the varying shapes of fruit and the need to adapt to their outer surfaces to apply sufficient suction. In some embodiments, the bellows-like design may comprise multiple convolutions, which may help to increase positioning tolerance in all three-dimensions. The increase in positioning tolerance may allow end portion 306 to misalign with the longitudinal axis 599 of the end effector 1341. That is, the end portion may flex so that the end face of the end portion 306 is not perpendicular to the suction element 316 and the longitudinal axis 599 of the end effector 1341. The multiple convolutions may help to absorb (dampen) shock when contacting a piece of fruit. The inherent cushioning of the bellows-like design allows the end face of the end portion 306 to adapt to different fruit surfaces to create a sufficient suction seal. For example, the end face of the end portion 306 may initially be flat and adopt a concave shape when contacting the piece of fruit.

The radius of the bellows-like design at its narrowest point may be no smaller than the radius of the suction element 316. The diameter of the bellows-like design at its widest point may be no larger than the diameter of a circle centred about the longitudinal axis 599 and having a radius equal the narrowest distance between the longitudinal axis 599 and each gripper portion 505a to 505n, when gripper 291 is in a contracted configuration and suction element 316 is retracted. Where, the circle centred about the longitudinal axis 599 lies on the same plane as the end face of end portion 306. That is, the bellows-like design will not be large enough that it will interfere with any gripper portion 505a to 505n when gripper 291 is in a contracted configuration and suction element 316 is retracted. In some embodiments, the material of the bellows-like design may have a durometer between 25° and 75° shore or between 30° and 60° shore, for example. In some embodiments, the material of the bellows-like design may have a combination of durometers between 25° and 75° shore or between 30° and 60° shore, for example.

End portion 306 may include an aperture in its end face. That is, the face of the end portion 306 opposite to that of the face connecting to the suction damper 590 may include an aperture in the centre of its end face. This aperture provides a pathway within the end portion 306 that connects internally to suction damper 590. This internal pathway may be connected to suction system 1344 via a plastic tube, for example. Suction system 1344 may create a vacuum within the internal pathway of end portion 306 and suction damper 590, providing suction to the piece of fruit via the aperture in the end face of end portion 306. In some embodiments, the vacuum pressure range may be determined by the type of fruit being pick by the robot. The vacuum pressure range may be between 0.6 megapascal and 1 megapascal for an apple, for example.

In some embodiments, pneumatic system 293 may comprise flow control valves 525, air cylinder 302, acrylonitrile butadiene styrene (ABS) blocks 550, decorative tube 555, and stopper 565. In some embodiments, pneumatic system 293 may actuate stage 1 piston 570 via methods described in pneumatic system 300. Flow control valves 525 may include a 2-position, 4-way, 5 ported valve. In some embodiments, pneumatic system 293 may actuate stage 2 piston 580 via methods described in pneumatic system 400. Flow control valves 525 may include a 3-position, 4-way, 5 ported open centre valve. In some embodiments, pneumatic system 293 may actuate both stage 1 piston 570 and stage 2 piston 580 at the same time independently of each other. In some embodiments, stopper 565 may limit the retraction of stage 1 piston 570 by blocking its path of travel in the direction of the longitudinal axis 599 of the end effector 1341. Air cylinder 302 includes cylinder cap 560 and cylinder base 545, creating a sealed cylinder for use in pneumatic system 293. ABS blocks 550 provide mounting points for decorative tube 555 to be coupled to. Decorative tube 555 may not be required, however it may offer protection from external elements damaging internal components of pneumatic system 293. In some embodiments, decorative tube 555 may enclose the components of pneumatic system 293.

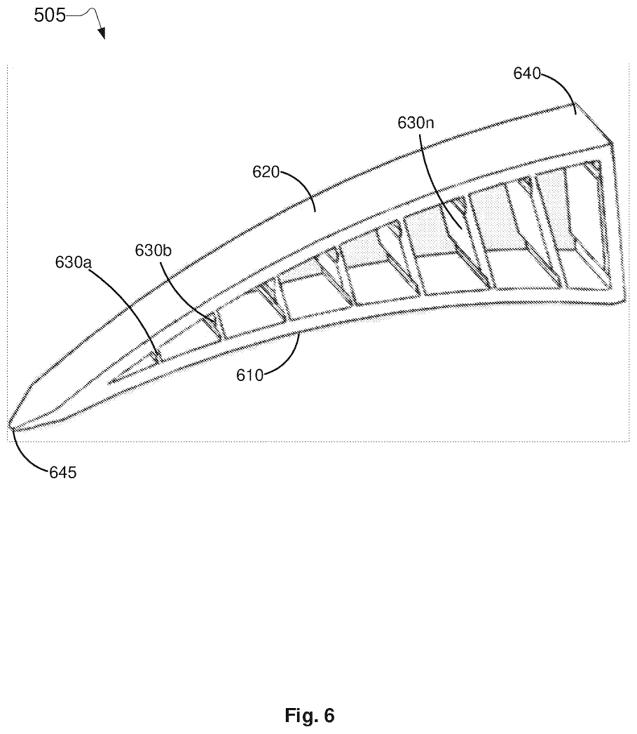

As illustrated in FIG. 6, each gripper portion 505 may comprise a first inner wall 610, a second outer wall 620, and a plurality of tendons 630a to 630n. The inner wall 610 is coupled to the outer wall 620 via the plurality of tendons 630. Gripper portion 505 may generally be considered to have a finger-like appearance. Where, the gripper portion 505 narrows progressively from a wide base at 640 to pointed (but not sharp) tip at 645. Inner wall 610 and outer wall 620 comprise a shape-adaptive flexible material such as thermoplastic polyurethane (TPU), thermoplastic elastomer (TPE), or thermoplastic copolyester (TPC) for example. The shape-adaptive flexible material may allow gripper portion 505 to at least partly conform to the shape of a piece of fruit when clasped. In some embodiments, inner wall 610 may include a silicone based surface finish to enhance gripping friction of each gripper portion 505.

Tendons 630 may comprise a lightweight and rigid metallic material such as aluminium, aluminium alloys, titanium, or titanium alloys, for example. Tendons 630 act to reduce moment forces within the cross-section of the gripper portion 505 to prevent undesired rotation along the longitudinal axis 599 when gripping a piece of fruit. This undesired rotation can result in loss of grip of the piece of fruit. In some embodiments, to account for the finger-like appearance of the gripper portion 505, tendons 630a to 630n may become progressively larger in terms or length and height from the tip to the base of the gripper portion 505. That is, a tendon 630a toward the tip may be smaller than tendon 630b, which is further from the tip and itself may be smaller than 630c, and so on for 630c to 630n, for example. This particular structure may allow the gripper portion 505 to have a natural curvature as illustrated in FIG. 6. The described tendon structure may also allow greater flexion in gripper portion 505 when actuated.

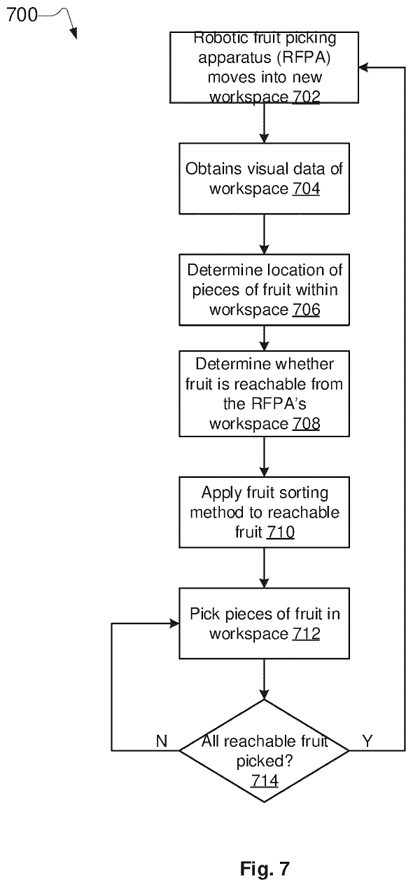

FIG. 7 illustrates a computer-implemented method 700 of locating pieces of fruit, determining a path to reach the located fruit, and picking fruit within a designated workspace of the RFPA 1000. In some embodiments, this method may be implemented by control system 200. At 702 of computer-implemented method 700, in some embodiments, processor 1310 executes movement module 1332 to move the RFPA 1000 via movement subsystem 1500 into a new workspace. The workspace will normally be a section of an orchard with pieces of fruit ready for picking and within the reach of the robotic fruit picking apparatus, for example. At 704, processor 1110 executes image processing module 1131 to obtain visual data of the workspace. In some embodiments, this visual data will be a stream of captured images, for example. At 706, image processing module 1131 is still being executed by processor 1110. The captured images are analysed and locations of pieces of fruit are determined. Location data for each piece of fruits centroid position is stored within memory 1130 by processor 1110. In some embodiments, the locations of pieces of fruit are added to a software defined fruit map, whereby the position of the fruit relative to the robot is recorded.

At 708, processor 1110 executes the pose estimation module 1133 to determine approach angles for the located pieces of fruit. Pose estimation is applied to the known pieces of fruit to maximise the number of reachable pieces of fruit within the workspace. Pose estimation comprises determining an appropriate approach angle for each piece of fruit. For example, a piece of fruit located high within the canopy should be approached and picked from below, rather than horizontally as this may cause the robotic arm to over extend. This over extension may cause the robotic arm to move outside of its operational workspace. The output of the pose estimation module 1133 undergoes optimisation of several factors. These factors include the arm workspace, velocity constraints, fruit surface occlusions, and collisions with rigid branches and canopy structures, for example. Fruit surface occlusions may include leaves and soft branches, for example.

Pose estimation module 1133 utilises a numerical optimisation to calculate approach angles for pieces of fruit. This numerical optimisation maximises the RFPA 1100 workspace, while ensuring inspection, grasping, and extraction trajectories remain feasible. The standard optimisation problem for a piece of fruit is as follows:

$$minimise x \qquad f ( x ) \qquad ( 1 )$$

$$\begin{matrix}constraints : & & {g}_{i} ( x ) \leq 0 , i = 1 , … , m & ( 2 ) \\ & & {h}_{j} ( x ) = 0 , j = 1 , … , n & ( 3 )\end{matrix}$$

$$\begin{matrix}Where : & equations 2 and 3 represent general \\ & functions of variable x .\end{matrix}$$

For a piece of fruit, function ƒ(x) of equation 1 is defined such that when it is minimised with constraints of equation 2 and equation 3, then the optimised approach angle for the piece of fruit is found. This optimised approach angle satisfies kinematic, as well as path and collision constraints. To increase the rate of determining successful picking paths of difficult to reach pieces of fruit, it has been identified that some constraints can be relaxed.

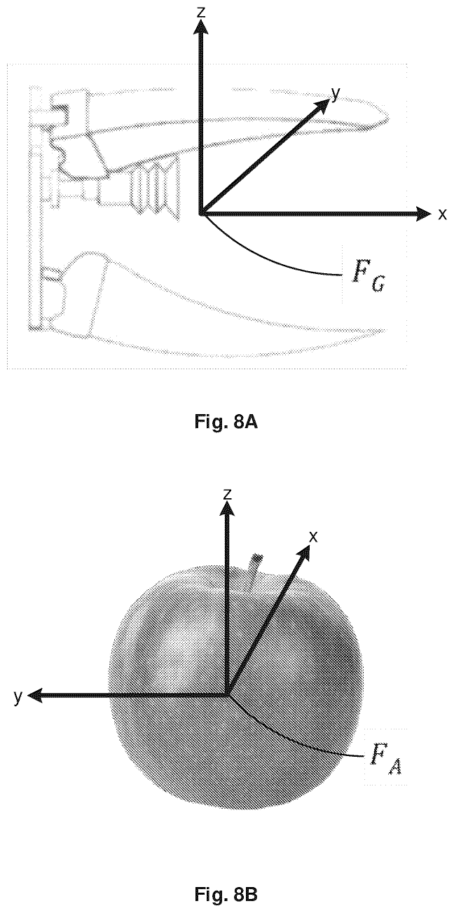

Within pose estimation module 1133 and path planning module 1132, via frames are defined as various points of interest within the workspace of the RFPA 1000. FIG. 8A and FIG. 8B illustrate gripper frame, F_{G}, and fruit frame, F_{A}. Fruit frame F_{A}, which represents a piece of fruit within the canopy, is considered a via frame. When picking a piece of fruit, the final gripper rotation is arbitrary in most cases. This allows the pose estimation module 1133 to determine approach angles where the y and z-axes of the gripper frame, F_{G}, are not strictly constrained, resulting in the following constraints of the gripper frame, F_{G}, when coincident with the fruit frame, F_{A}, for picking:

$$\begin{matrix}constraints : & & {p}_{G} = {p}_{A} & ( 4 ) \\ & & {\vec{X}}_{G} \cdot {\vec{X}}_{A} = 1 & ( 5 )\end{matrix}$$

Wherein, the constraint of equation 4 implies that the origin of the gripper frame and fruit frame are equal. The constraint in equation 5, the x-axes of both the gripper frame, F_{G}, and the fruit frame, F_{A}, are in the same direction. Processor 1110 executing pose estimation module 1133 utilises these constraints to differentiate between pieces of fruit that are able to picked and pieces of fruit that are unable to be picked within the RFPA 1000 workspace.

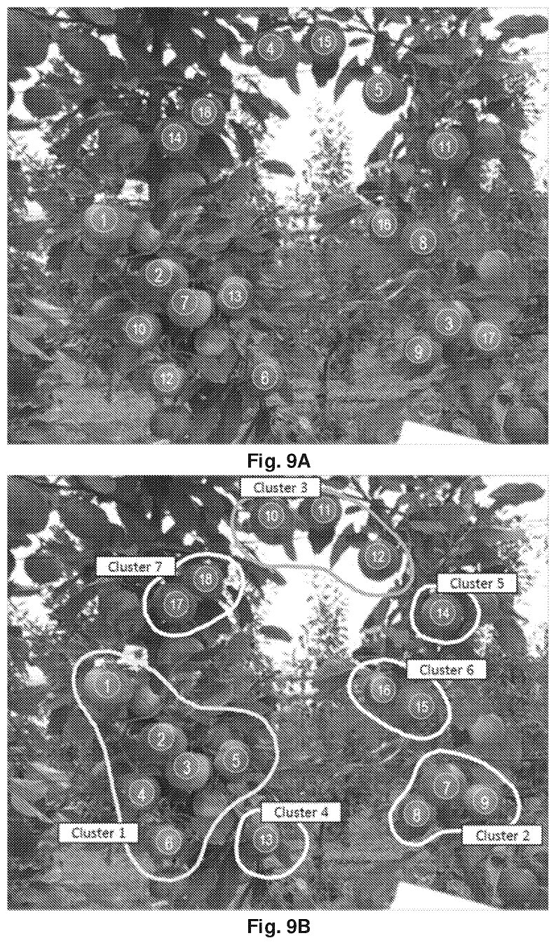

At 710, processor 1110 executes sorting module 1134. To date, only basic sorting methods have been utilised by modern robotic harvesters. An example is a depth-priority sort, wherein the picking order is defined based on distance from a point of reference. The depth-priority search approach is simplistic, yet minimises disturbance to other fruit by picking from the outside in. However, the depth-priority search approach is not considered time-optimal for canopies favouring clustered growth, such as apples, for example. As shown in FIG. 9A, the depth-priority sort results in a fruit picking order that includes haphazard paths for the gripper, wherein the gripper travels large distances between pieces of fruit. This reduces harvesting efficiency and has the potential to disturb large areas of the orchard canopy.

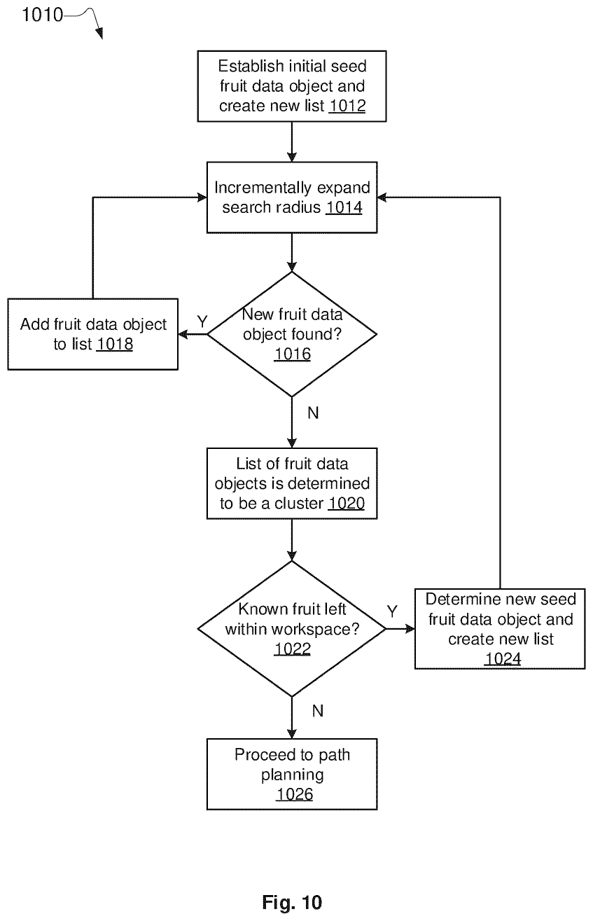

The sorting module 1134 of the RFPA 1000, when executed by processor 1110, utilises a greedy-search approach, wherein additional optimisation constraints are added to result in a cluster output as illustrated in FIG. 10. A greedy approach is a method that follows the problem-solving heuristic of making the locally optimal choice at each stage. At 1012, processor 1110 executing sorting module 1134, establishes a seed fruit data object determined initially by closest depth of fruit determined to be able to be picked, and a new list to store fruit data objects within. As shown in FIG. 8A, the closest piece of fruit able to be picked is marked with a 1, this is the initial seed fruit data object. From the location of the initial seed fruit data object a search radius is expanded incrementally at 1014. At 1016 for every increment, the sorting module 1134 checks whether a new fruit data object is within the expanded search radius. If a new fruit data object is found, it is added to the list at 1018. If no new fruit data object is found, then all fruit data objects within the current list are determined to be a cluster at 1020, as executed by processor 1110.

At 1022, the sorting module 1134 checks if there are any known fruit data objects left within the workspace that are not within a cluster. If so, at 1024, the closest fruit data object not within a cluster is selected as a new seed fruit data object and a new list is created. The processor 1110, will then repeat the aforementioned processes, returning to 1014, until all fruit data objects within the workspace are in a cluster as shown in FIG. 9B. When it is determined that all of the clusters have been found, the sorting is finished and processor 1110 will proceed to execute path planning at 1026. Example pseudocode of the cluster-priority search approach is shown below:

Sorting Module: Cluster-priority search

```
Input:
Position of robot base p_{b} ∈ [symbol]   ³
Initial cluster radius d₀ = 0.1 (metres)
Definitions:
Let a = (p, r, D) which is a tuple representing a piece of fruit, where p ∈ [symbol]   ³ is
the fruits centroid position, r = |p − p_{b}|, and D is a generic data struct.
Let A = {(p₁, r₁, D₁), (p₂, r₂, D₂), ... , (pₙ, rₙ, Dₙ)}, the set of all reachable fruit a.
Let A(i) = aᵢ, which is the i-th piece of fruit expressed as tuple (pᵢ, rᵢ, Dᵢ) in A.
Given aᵢ, also let p(aᵢ) = pᵢ and r(aᵢ) = rᵢ. In this module atis the seed fruit.
Let r(A) be the set of all r from each tuple in the set of fruit A.
Let A_{c} = (Aₗᵢₛₜ, j) which is an ordered pair, Aₗᵢₛₜ ⊂ A is a fruit cluster and j ∈ [symbol]
is the j-th cluster to be harvest by the robot.
Output:
A_{cluster} = {(Aₗᵢₛₜ, 1), (Aₗᵢₛₜ, 2), ... , (Aₗᵢₛₜ, n)} is the set of ordered pairs A_{c}
representing reachable clusters of fruit and their harvesting order.
while |A| > 0 do
  | d = d₀
  | j = 1
  | rᵢ = min(r(A))
  | aᵢ = A(i)
  | A = A {aᵢ}
  | while |A| > 0 do
  | | A_{close} = {a ∈ A: |p(a) − p(aᵢ)| < d}
  | | if |A_{close|} > 0 then
  | | | Aₗᵢₛₜ = Aₗᵢₛₜ ∪ A_{close}
  | | | A = A\A_{close}
  | | | d = d + 0.05
  | | else
  | | | A_{c} = (Aₗᵢₛₜ, j)
  | | | A_{cluster} = A_{cluster} ∪ A_{c}
  | | | j = j + 1
  | | end
  | end
end
```

The cluster-priority search method provides two major advantages. The first being opportunity to optimise the robotic trajectories when considering clusters of fruit. That is, when a fruit cluster is harvested, the robot will continuously harvest in the same area. The paths calculated for fruit within the same cluster will be similar. Utilising this condition, the optimised trajectory of a path to a single piece of fruit can be applied to all closely neighbouring fruit within the same cluster. This will significantly reduce computational redundancy when calculating trajectories for picking each piece of fruit, allowing the robot to move efficiently between fruit. The second advantage is a reduction in canopy disturbance when picking fruit. In standard robotic harvesting, the canopy of an orchard is often disturbed, causing fruit to undesirably change positions or dislodge, reducing effectiveness of the harvester. Harvesting within clusters limits disturbances to the cluster area, leaving the remaining workspace unperturbed. This limit in disturbances reduces the number of visual updates required to re-determine fruit locations due to additional movement. The outcome of using this new cluster-priority search approach is a more energy and time efficient approach, resulting in reduced cost and/or increased picking efficiency.

Following the execution of the sorting module 1134, processor 1110 executes path planning module 1132. Path planning module 1132 determines a dataset to output to mechanical manipulation subsystem 1300 containing end effector 1341, robotic arm 1342, and suction system 1344 movement commands for picking fruit in the order determined via sorting module 1134. Path planning module 1134 determines the optimal paths of the mechanical elements of the RFPA 1000 by implementing a number of kinematic and collision constraints.

The path planning module 1132 optimises rotation of the aforementioned fruit frame, F_{A}, such that the minimum amount of rotation is required. This optimisation is subject to constraints, such as being collision-free and ensuring a valid path exists. Fruit frame, F_{A}, is in essence a proposed gripper frame, F_{G}, when grasping the piece of fruit, therefore the final gripper rotation position is arbitrary. This allows the optimisation problem to omit rotation about the x-axis of the gripper frame, F_{G}, resulting in the following objective function:

$$\begin{matrix} & & f ( x ) = {γ}^{2} + {β}^{2} & ( 6 ) \\ Where : & & x = {[ \begin{matrix}γ & β\end{matrix} ]}^{T} & \\ and & & γ and β are the rotations about the fruit ' s & \\ & & z and y - axes respectively . & \end{matrix}$$

Further constraints are added such that the optimised path guarantees an inverse kinematic solution.

$$\begin{matrix}\text{Let:} & & {}^{B} {p}_{A 0} and {}_{A 0}^{B} R be the position and rotation of the initial & \\ & & fruit frame {F}_{A 0} relative to the robot base frame {F}_{B} , where & \\ & & {F}_{B} is a selected origin coordinate of the robot . & \\ \text{Find:} & & {}_{A}^{A 0} R = R ( γ ) R ( β ) & ( 7 ) \\ & & {}_{A}^{B} R = {}_{A 0}^{B} R {}_{A}^{A 0} R & ( 8 ) \\ & & {}^{B} {p}_{E} = {}_{A 0}^{B} {R}_{A}^{A 0} {R}^{A} {p}_{E} & ( 9 ) \\ \text{Where:} & & {}^{A} {p}_{E} = {}^{G} {p}_{E} according to equation 4 when grasping . & \end{matrix}$$

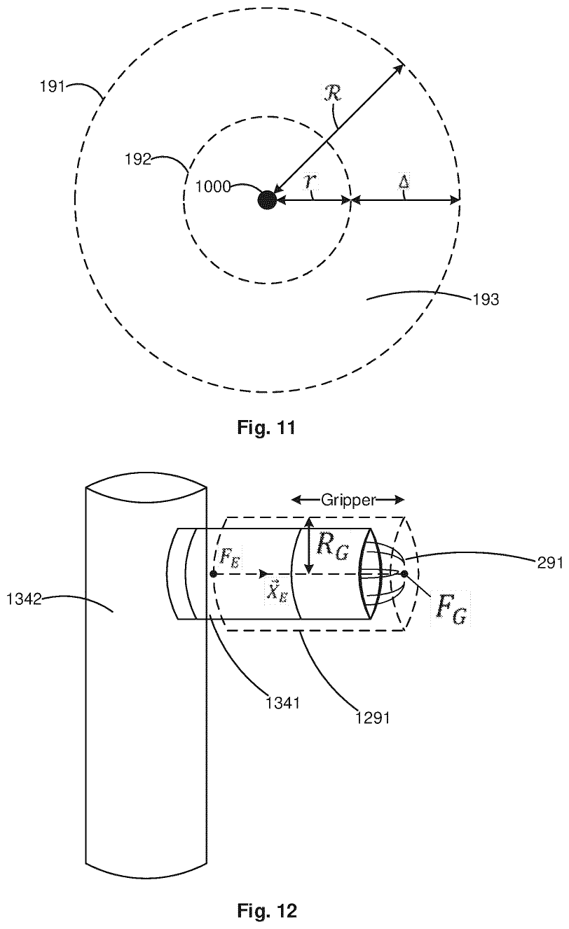

The path planning module 1132 aims to find the rotation (equation 7) to apply to fruit frame F_{A0} such that the grasp is optimised while satisfying kinematic and additional constraints. Equation 8 shows the rotation matrix of the new fruit frame F_{A}. Equation 9 shows the position of the end effector, given F_{A0} and the applied rotation of equation 7. The position of the end effector will be used to constrain the path via kinematics. Introducing an inner workspace boundary 191 and outer workspace boundary 192, as shown in FIG. 11, wherein the inner workspace boundary 191 is defined by the minimum region within which the robotic arm 1342 and end effector 1341 can move. The inner workspace boundary 191 has a radius defined by r. Further, the outer workspace boundary 192 is defined by the maximum region within which the robotic arm 1342 and end effector 1341 can move. The outer workspace boundary 192 has a radius defined by R. A RFPA workspace 193 is defined by the inner workspace boundary 191 and outer workspace boundary 192, such that the annulus of the RPFA workspace 193 is Δ=R−r. For both the inner workspace boundary 191 and outer workspace boundary 192, the RFPA workspace 193 is relatively uniform such that at least one inverse kinematic solution exists when the RFPA 1000 end effector frame F_{E} is within the workspace boundaries. The end effector frame F_{E} and the gripper frame F_{G} are not coincident, resulting in a transformation matrix _{G}^{E}T that is non-identity. The resulting inequality constraints are:

$${g}_{( 1 , 1 )} ( x ) = \vert {}^{B} {p}_{E} ( x ) \vert - ℛ \qquad ( 10 )$$

$${g}_{( 1 , 2 )} ( x ) = r - \vert {}^{B} {p}_{E} ( x ) \vert \qquad ( 11 )$$

$$\text{Where:} g is as previously described .$$

A kinematic solution for the path of the end effector 1341 is guaranteed to exist if equation 1 is optimised and equation 10 and equation 11 satisfy the constraints of equation 2. Furthermore, a grasping trajectory for a piece of fruit may follow a series of via frames, for example:

$$\begin{matrix} & {p}_{{V}_{1}} = {p}_{A} \to {p}_{G} = {p}_{A} \to {p}_{{V}_{2}} = {p}_{A} & ( 12 ) \\ \text{Where:} & {p}_{{V}_{1}} and {p}_{{V}_{2}} are positions of via frames that are attached & \\ & relative to {F}_{G} , resulting in further inequality constraints : & \\ & {g}_{( 2 , 2 n - 1 )} ( x ) = \vert {}^{B} {p}_{{V}_{n}} ( x ) \vert - ℛ & ( 13 ) \\ & {g}_{( 2 , 2 n )} ( x ) = r - \vert {}^{B} {p}_{{V}_{n}} ( x ) \vert & ( 14 ) \\ \text{Such that:} & n via points remain within the workspace boundaries & \\ & when equation 1 is optimised and equation 13 and & \\ & equation 14 satisfy equation 2 . & \end{matrix}$$

The path planning module 1132 also considers collisions when optimising the path of the robotic arm 1342 and end effector 1341. The first source of collision considered is the workspace environment which may comprise branches, building structure, or foliage, for example. The second source of collision considered is the RFPA 1000. In other words, the robotic arm 1342 and end effector 1341 may collide with the RFPA 1000 and/or any of the elements of chassis 1050. This form of collision is called self-collision. Self-collision checks are executed by processor 1110 via path planning module 1132 post optimisation. The design of the robotic arm 1342 allows for a minimum number of kinematic solutions to safely avoid self-collisions at most end effector positions. Checking for self-collisions post optimisation reduces computational cost. In some embodiments, processor 1110 executing path planning module 1132 may, after determining end effector paths to pick pieces of fruit, check the path to determine whether self-collision takes place. If self-collision occurs, path planning module 1132 executed by processor 1110 will alter the path containing a collision to avoid self-collision.

Collisions with the environment are considered during optimisation when path planning module 1132 is executed by processor 1110 to prevent end effector collision with the workspace environment.
Let: c∈ [symbol] ³ be a point defined in set C, where C is the point cloud of the workspace environment.
   C_{B}⊂C be the set of points representing all inadmissible collision objects (trunks and branches)
   R_{G} be the collision radius surrounding the gripper 291.
   The collision object may be a virtual cylinder 1291 of radius R_{G} between the points represented by F_{E} and F_{G} along the longitudinal axis 599 of the end effector \vec{X}_{E} as shown in FIG. 12.
Assume: F_{E} is at ^{B}p_{E} and F_{G} is at ^{B}p_{G}
Point c∈C_{B} lies within the collision cylinder if:

$$\begin{matrix} & & 0 \leq r \leq 1 & ( 15 ) \\ \text{Where:} & & r = \frac{( {p}_{E} - {p}_{G} ) \cdot ( {p}_{E} - c )}{\vert {p}_{G} - {p}_{E} \vert} & ( 16 ) \\ \text{and if:} & & d \leq {R}_{G} & ( 17 ) \\ \text{Where:} & & d = \vert ( {p}_{G} - {p}_{E} ) r + {p}_{E} - c \vert & ( 18 )\end{matrix}$$

Using the above, where p_{G} and p_{E} are derived from x, equation 15 and equation 17 can be represented as inequality constraints.

$$\begin{matrix} & & {g}_{( 3 , 3 n - 2 )} ( x ) = - r ( x ) & ( 19 ) \\ & & {g}_{( 3 , 3 n - 1 )} ( x ) = r ( x ) - 1 & ( 20 ) \\ & & {g}_{( 3 , 3 n )} ( x ) = d ( x ) - {R}_{G} & ( 21 )\end{matrix}$$

$$\text{Such that:} For every n - th point c ∈ {C}_{B} .$$

Therefore point c is within a virtually defined collision cylinder. In other words, point c will be considered to collide with end effector 1341, if any of equation 19, equation 20, or equation 21, do not satisfy the condition in equation 2. All points within C_{B} must be outside of the collision cylinder for the path to be determined as collision-free and satisfy the constraints described herein. The output of path planning module 1132, when executed by processor 1110, is a dataset input for mechanical manipulation subsystem 1300. Processor 1310 may execute arm manipulation module 1331 to process the dataset input and to manipulate the robotic arm 1342 and then end effector 1341.

FIGS. 13A and 13B and FIGS. 14A and 14B illustrate a gripper 291 in both a contracted and expanded configuration, respectively. The end effector 1341 will approach a piece of fruit with the gripper 291 in the contracted position as shown in FIG. 13A. This allows the end effector to form a narrow profile or point at its end so that it may more effectively pierce through the canopy and push aside any twigs, foliage, or other small objects. As the end effector reaches the piece of fruit for picking, the gripper 291 is controlled by the arm manipulation module 1331 to take on the expanded position as shown in FIG. 14A. This allows the gripper 291 to prepare to grasp the piece of fruit, but also helps to push aside twigs, foliage, or other small objects within close proximity to the gripper fingers 505a to 505n. The method of utilising the pointed gripper fingers of the end effector to pierce the canopy and push aside objects is called a “go-through strategy”. This strategy is key for picking pieces of fruit in dense canopies where objects such as small twigs and foliage are not considered collision obstacles when determining a fruit picking path.

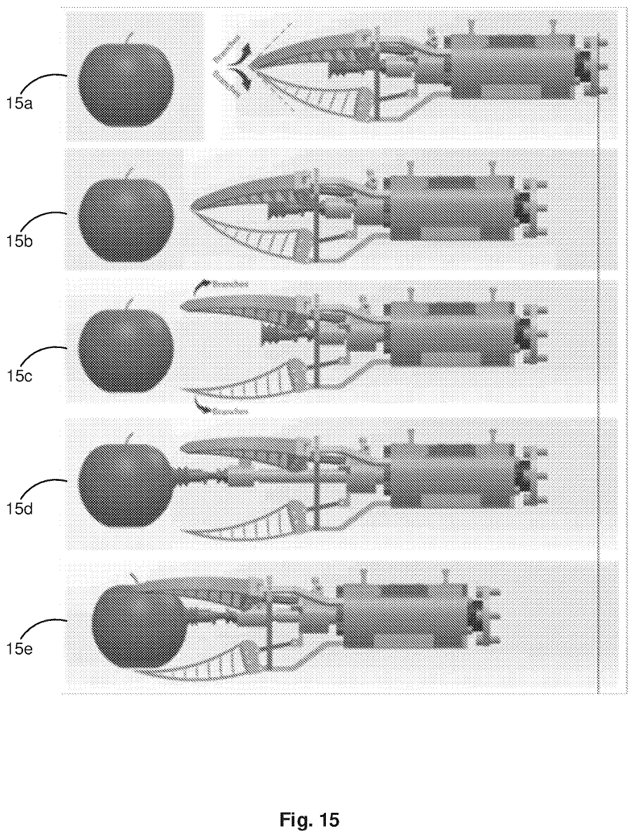

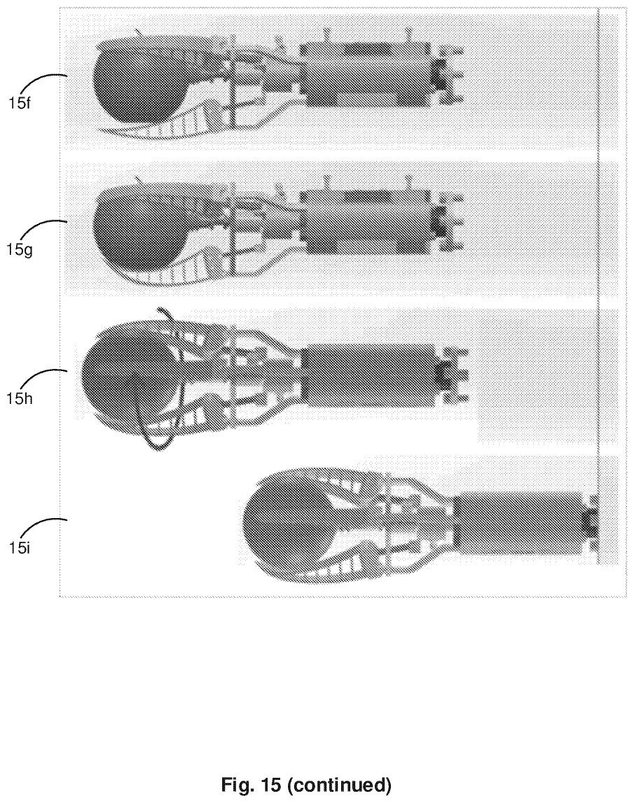

FIG. 15 illustrates a control sequence of the end effector 1341 and robotic arm 1342 when picking a piece of fruit. At 15a, the robotic arm 1342 moves the end effector 1341 towards a piece of fruit. As the end effector 1341 approaches the piece of fruit, gripper 291 pneumatically actuated to adopt a contracted configuration to implement the “go-through strategy” as described herein. At 15b, the end effector 1341 arrives at the piece of fruit for picking. At 15c, gripper 291 is pneumatically actuated to adopt an expanded configuration, pushing away any objects in close proximity of the gripper fingers 505a to 505n. At 15d, the suction element 316 is extended from the end effector 1341 towards the piece of fruit. The end portion 306, creating a vacuum as previously described, contacts the piece of fruit and applies suction to the piece of fruit to retain it. The suction element 316 is put in the passive state where the suction element 316 can freely move along the longitudinal axis 599 of the end effector 1341 while maintaining the applied suction. At 15e, the robotic arm 1342 moves the end effector 1341 towards the piece of fruit, allowing the gripper 291 to surround the piece of fruit. At 15f, the gripper 291 is pneumatically actuated to contract the gripper fingers 505a to 505n around the piece of fruit in order to grasp it. At 15g, the gripper 291 securely grasps the piece of fruit, the gripper fingers 505a to 505n conforming to the shape of the piece of fruit. At 15h, the robotic arm 1342 rotates the end effector 1341 about its longitudinal axis 599 to dislodge the piece of fruit from its stem while maintaining hold of the piece of fruit. The robotic arm 1342 then retracts the end effector 1341 at 15i, removing the end effector 1341 and the piece of fruit from the canopy.

In some embodiments, following the control sequence illustrated in FIG. 15, the RFPA 1000 may deposit the piece of fruit in a storage container. The storage container may be a bucket, a bag, or a bin, for example. The robotic arm 1342, after retracting the end effector 1341 at 15i of FIG. 15, may direct the end effector 1341 and the piece of fruit towards the storage container. The end portion 306 will then stop applying suction to the piece of fruit, and suction element 316 will retract, as previously described. The end effector 1341 will then pneumatically actuate gripper 291 to adopt an expanded configuration, releasing the piece of fruit into the storage container.

### Alternate Control System Architecture

FIG. 2 illustrates an alternate second control system 200 of the RFPA 1000 according to some embodiments, comprising central control unit 205 and gripper control unit 255. Central control unit 205 comprises a processor 210 and a memory 230 accessible to processor 210. Processor 210 is configured to access data stored in memory 230, to execute instructions stored in memory 230, and to read and write data to and from memory 230. Memory 230 may be configured to store data and executable applications for execution by processor 210. For example, memory 230 may store data in internal memory 230 configured for access by processor 210.

Central control unit 205 oversees control of vision subsystem 1100, power subsystem 1400, and movement subsystem 1500, and is capable of storing and retrieving data from each subsystem's memory, as well as executing instructions stored within each subsystem's memory. In some embodiments, program data, modules, and instructions for performing the functions of each subsystem, including the vision subsystem 1100, the power subsystem 1400, and the movement subsystem 1500, may be stored in internal memory 235 and be executable by processor 210. In some embodiments, the central control unit 205 may communicate operation instructions to each subsystem, including the vision subsystem 1100, the power subsystem 1400, and the movement subsystem 1500, to execute using their own respective processors and data stored within their own respective memory modules.

In some embodiments, processor 210 of central control unit 205 may execute image processing module 1131, path planning module 1132, pose estimation module 1133, and/or sorting module 1134 of vision subsystem 1100 as described herein. The dataset output of path planning module 1132 for manipulation of the robotic arm 1342 and end effector 1341 may be an input to gripper control unit 255.

To facilitate communication with gripper control unit 255, central control unit 205 further comprises a communications module 220. Communications module 220 may allow for wired and/or wireless communication between central control unit 205 and gripper control unit 255, and in some embodiments, external computing devices and components. According to some embodiments, communication module 220 may facilitate communication with internal devices and systems via internal network 1200.

Gripper control unit 255 comprises a processor 260 and a memory 280 accessible to processor 260. Processor 260 may be configured to access data stored in memory 280, to execute instructions stored in memory 280, and to read and write data to and from memory 280. Memory 280 may be configured to store executable applications for execution by processor 260. For example, memory 280 may store manipulation module 282 configured for access by processor 260.

To facilitate communication with central control unit 205, gripper control unit 255 further comprises a communications module 270. Communications module 270 may allow for wired and/or wireless communication between gripper control unit 255 and central control unit 205. According to some embodiments, communication module 270 may facilitate communication with internal devices and systems via internal network 1200.

Gripper control unit 255 controls operation of the end effector 1341. The gripper control unit 255 receives control signals for end effector manipulation and pneumatic actuation from central control unit 205 via communications module 270. The gripper control unit 255 then processes the received control signals via processor 260 to manipulate and/or actuate the end effector 1341 systems as desired by central control unit 205. In some embodiments, processor 260 of gripper control unit 255 may execute manipulation module 282 to process the dataset output of path planning module 1132.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A robotic fruit picking apparatus, including:
a chassis;
a robotic arm supported by the chassis and having an end effector, wherein the end effector includes a plurality of grippers and an extendable suction element;
a vision system carried by the chassis and configured to identify pieces of fruit for picking; and
a control system carried by the chassis and in communication with the vision system to control the robotic arm to pick identified pieces of fruit using the end effector;
wherein the control system is configured to operate in a first mode to control the extendable suction element to extend the suction element towards a piece of fruit; and
wherein the control system is configured to operate in a second mode following the first mode to retain contact with the piece of fruit by applying suction while freely allowing extension or retraction of the suction element based on the movement of the piece of fruit.

2. The apparatus of claim 1, wherein the plurality of grippers comprise gripper fingers.

3. The apparatus of claim 2, where each of the gripper fingers has an inner wall and an outer wall coupled to the inner wall by a plurality of tendons.

4. The apparatus of claim 3, wherein each gripper finger includes a plurality of reinforcing plates to reinforce the respective tendons.

5. (canceled)

6. The apparatus of claim 1, wherein the gripper includes three, four or five gripper fingers.

7. The apparatus of claim 1, wherein the suction element includes a suction aperture defined by an end face of the suction element.

8. (canceled)

9. (canceled)

10. The apparatus of claim 1, further including a suction line and a pressure sensor to sense pressure in the suction line, wherein the suction line runs through the suction element and the pressure sensor is configured to provide a pressure output signal to the control system, wherein the control system is configured to determine whether the suction element has applied suction to a piece of fruit based on the pressure output signal.

11. (canceled)

12. The apparatus of claim 1, wherein the vision system is configured to identify, from the captured and processed images, pieces of fruit for picking and sort them into a picking order, and to provide the output to the control system.

13. The apparatus of claim 1, wherein the vision system is used in pose estimation to determine the path of the robotic arm.

14. The apparatus of claim 1, wherein the imaging subsystem is configured to identify interference objects in the images, and to output interference object identification information to the control unit, and the control unit is configured to determine movement of the robotic arm and end effector to avoid collision with the interference objects based on the interference object identification information.

15. The apparatus of claim 1, wherein the control system is configured to operate the suction element in a retraction mode, after either the extension mode or passive mode, to retract the suction element towards the one end of the robotic arm.

16. The apparatus of claim 1, wherein the control system is configured to control the gripper to adopt an expanded position where the gripper fingers are expanded about a longitudinal axis of the end effector and a contracted position where the gripper fingers are contracted about the longitudinal axis of the end effector.

17. (canceled)

18. The apparatus of claim 1, further including a movement system coupled to the main body to facilitate movement of the main body relative to ground.

19. A robotic fruit picking apparatus, including:
a main body;
a robotic arm coupled to the main body;
an end effector coupled to a first end of the robotic arm, the end effector including:
a gripper including a plurality of gripper portions to grip a piece of fruit;
a suction member extendable from the end effector; and
a control unit carried by the main body and configured to operate the suction member in an extension mode to apply suction and extend the suction member from the end effector towards the piece of fruit, and to operate the suction member in a passive mode after the extension mode, wherein in the passive mode, the suction member can move freely relative to the gripper while applying the suction.

20. The apparatus of claim 19, further including a vision system coupled to the main body comprising:
image capturing devices;
wherein the vision system is configured to use the image capturing devices to identify pieces of fruit for picking.

21. The apparatus of claim 20, wherein the vision system is further configured to determine a collision free picking path for the apparatus to pick fruit.

22. A computer-implemented method for picking pieces of fruit, the method comprising:
operating a robotic end effector in an extension mode to extend a suction element toward a piece of fruit, wherein the suction element is configured to apply suction to the piece of fruit;
operating the end effector in a passive mode, wherein in the passive mode the suction element can move freely in a longitudinal direction along a longitudinal axis of the end effector while applying suction by the suction element to the piece of fruit;
directing the end effector towards the piece of fruit to pick the piece of fruit.

23. The computer-implemented method of claim 22, wherein the method further comprises:
actuating a gripper coupled to the end effector to grasp the piece of fruit for picking;
rotating the end effector about a longitudinal axis of the end effector to dislodge the piece of fruit.

24. The computer-implemented method of claim 22, wherein the method further comprises:
directing the end effector towards a storage container;
operating the end effector in a retraction mode to retract the suction element toward the end effector, wherein the suction element stops applying suction to the piece of fruit;
actuating the gripper of the end effector to release the piece of fruit into the storage container.

25. The computer-implemented method of claim 22, wherein the method further comprises:
generating a software-defined fruit map based at least in part on data received by a vision system;
determining a harvesting sequence based at least in part on the fruit map;
determining an end effector approach angle for each piece of fruit within the fruit map based at least in part on the fruit map, the harvesting sequence, and pose estimation.

26. (canceled)
